(19) United States
(12) Patent Application Publication
(10) Pub. No.: US 2026/0213535 A1
(43) Pub. Date: Jul. 23, 2026

(54) RETROFITTABLE FRACTIONALLY-RATED ACTIVE GRID DAMPENING SYSTEM AND METHOD FOR HIGH DISTRIBUTED ENERGY RESOURCES PENETRATION GRID

(71) Applicant: GEORGIA TECH RESEARCH CORPORATION, Atlanta, GA (US)

(72) Inventors: Deepak M. DIVAN, Atlanta, GA (US); Joseph Benzaquen SUNE, Atlanta, GA (US)

(21) Appl. No.: 19/135,727

(22) PCT Filed: Dec. 6, 2023
(86) PCT No.: PCT/US2023/082744

§ 371 Date: Jun. 4, 2025

Related U.S. Application Data
(60) Provisional application No. 63/386,247, filed on Dec. 6, 2022.

(51) Int. Cl. H02J 3/0014; G05B 9/02; H02J 3/001; H02J 3/1807; H02J 3/1821; H02J 3/32; H02J 3/38

(52) U.S. Cl. CPC H02J 3/0014; G05B 9/02; H02J 3/001; H02J 3/1807; H02J 3/1821; H02J 3/32; H02J 3/38

(57) ABSTRACT

An exemplary retrofittable, fractionally-rated active grid dampening system and method that can be employed at existing utility substations and minimally at the high voltage transformers to retrofit existing passive high voltage transformers to grid-forming assets for high distributed-energy-resource penetration in the grid, to provide (i) steady-state voltage, impedance, VARs, power flow control, congestion management capabilities, (ii) Grid forming capability, including inertial support, improving grid stability, (iii) series and parallel damping of oscillations and interaction capabilities, (iv) multi-vendor inverters utilization without need for grid interactions; and (v) black-start capability.

### RELATED APPLICATION

This PCT application claims priority to, and the benefit of, U.S. Provisional Patent Application No. 63/386,247, filed Dec. 6, 2022, entitled “GridFormer—System and Method to Stabilize and Manage a High IBR Penetration Grid,” which is incorporated by reference herein in its entirety.

### BACKGROUND

Today, grid forming is done by synchronous generators. As the grid transitions to increasing levels of distributed energy resources (DERs), the ability to maintain a stable grid becomes challenging. DERs have been deployed in the grid and are equipped with Grid-Following (GFL) controls having dispatchable active and reactive power. Extensive research has been conducted to understand the stability of GFL converters on the grid at various short-circuit-level (SRC) scenarios; nevertheless, the interactions that arise from a system with a high IBR penetration remain a central challenge to scale the current grid to a carbon-free grid.

Increasing distributed energy resource penetration, driven by rapidly declining prices of PV solar and energy storage, is occurring at a pace faster than the grid can handle. Local inverter-based resources (IBRs) at distributed generation sites and centralized sites do not have a system-wide view of the grid, and their inclusions can introduce instability. In one estimate, 750 GW of non-compliant IBRs are planned to be deployed in the US grid by 2035. This issue is compounded by the fact that millions of inverters from hundreds of vendors have to be coordinated and synchronized.

Even with grid-code-compliant commercially available GFM solutions, functional interoperability challenges remain a concern that can limit DER scaling when deploying inverters from various vendors and technology cycles to the grid. Grid operators in Europe, Australia, and some regions in the US (western) are grappling with high IBR penetration systems issues of reduced inertia, low-frequency tripping of protective relays, interactions between inverters and with other grid elements, and inter-area oscillations. These factors all suggest that the transition from a centrally controlled, largely passive electromechanical grid to a new grid with active elements at the grid-edge represents a new paradigm. Failing to address these issues in a timely manner can slow down or derail the progress we are making in our transition to a green and sustainable energy infrastructure.

The majority of the current and future deployment of IBRs are centered around grid-following (GFL) technologies, which rely on a significant presence of synchronous generators to slow the system dynamics and allow for the GFL controllers to accurately track the grid voltage and inject the appropriate current/power. Nevertheless, as IBR penetration increases and synchronous generators are decommissioned or replaced by synchronous condensers, the transient and small-signal stability margins of the system are dramatically reduced. According to certain studies, challenges increase dramatically when IBRs serve more than 65% of the system load. Moreover, the deployment of IBRs across different technology cycles and vendors further hinders the scaling.

Recently, the notion of Grid Forming (GFM) inverters has been developed and promises enhanced performance and functionality compared to GFL (e.g., inertia, damping, and improved stability, among others) that integrate a large power transformer with power electronics to achieve a hybrid structure that could provide flexibility, power routing, and voltage control capability in the steady-state. However, the projects did not address several fundamental issues of dynamic control, including grid-forming, inertia, damping, and black start. These issues have become visible over the last few years and pose a big challenge to the continued rapid growth of an IBR-dominant grid.

There is a need to improve utility-owned or controlled resources.

### SUMMARY

An exemplary retrofittable, fractionally-rated active grid dampening system (also referred to herein as “GridFormer” device) and method are disclosed that can be employed at existing utility substations and minimally at the high voltage transformers to retrofit existing passive high voltage transformers (as well as medium voltage transformers) to grid-forming assets for high distributed-energy-resource penetration in the grid, to provide (i) steady-state voltage, impedance, VARs, power flow control, congestion management capabilities, (ii) Grid forming capability, including inertial support, improving grid stability, (iii) series and parallel damping of oscillations and interaction capabilities, (iv) multi-vendor invertor interoperability without need for grid interactions; and (v) black-start capability.

Replacement of large power transformers can have a huge impact on the system and can take 12-18 months to perform. The exemplary retrofittable, fractionally-rated active grid dampening system can be deployed at sub-stations and then connected in series on the neutral side winding of the large power transformers as a quick retrofit solution without replacement of the transformer. Additionally, the exemplary retrofittable, fractionally-rated active grid dampening system provides an overall design topology that can also be implemented at scale using existing low-cost standard building block power conversion equipment, e.g., motor drives, that are currently built at scale and that are fractionally rated for the voltage rating of the medium or high voltage transformer.

The exemplary retrofittable, fractionally-rated active grid dampening system can address several major challenges that the utility industry is grappling with today. It can be employed to allow a utility-owned resource to stabilize the grid and to allow rapid growth of connected distributed energy resources. It may be employed to allow a retrofit of this new capability at a low cost to existing large assets, such as large power transformers, at existing substations. This can also prevent a major disruption of the electricity sector as they manage the energy transition to a decarbonized grid.

In an aspect, a system is disclosed comprising: system terminals, including (i) a first input terminal, or a set thereof, and (ii) a second output terminal, or a set thereof, to couple in series to a secondary-side winding of a distribution or transmission transformer (e.g., a passive three-phase medium or high voltage transformer or three single-phase medium or high voltage transformers) of a distribution or transmission system; a first stage disconnection switch having a disconnection switch device that couples of the first input terminal, or the set thereof, of the system terminals; a second stage conversion and energy storage module coupled to the first stage fail-normal disconnection switch, the second stage conversion and energy storage module comprising a series converter and a shunt converter coupled to one or more energy storage equipment via a DC bus, a third stage transformer comprising a transformer having a first winding side and a second winding side, the first winding side coupled to outputs of the second stage conversion and energy storage module, and the second winding side coupled to the second output terminal or a set thereof; and a controller operatively coupled to the series converter and the shunt converter, the controller being configured, via computer readable instructions, to direct operation of the series converter and the shunt converter through the third stage transformer and the one or more energy storage equipment, as a network transient damper, to (i) control steady-state line power flow and voltages at the distribution or transmission transformer, and (ii) provide dynamic shunt and series damping to grid transients at the distribution or transmission transformer (e.g., to provide inertial support and grid forming capability to support the distribution or transmission system).

In some embodiments, the distribution or transmission transformer is configured with a first power rating, wherein the series converter and the shunt converter are configured with components for a second power rating, wherein the transformer is configured with components for a second power rating, the second power rating and the third power rating being less than 20% of the first power rating (e.g., less than 10%).

In some embodiments, the controller is configured, via the computer readable instructions, to direct the operation of the series converter and the shunt converter, to provide the dynamic shunt and series damping to grid transients through the third stage transformer and the one or more energy storage equipment, including load transient damping, power oscillation damping, black-start, and low-voltage or line short-circuit ride-through.

In some embodiments, the series converter and/or shunt converter comprises a standard or off-the-shelf motor-drive back-to-back inverter.

In some embodiments, the standard or off-the-shelf motor-drive back-to-back inverter includes a bidirectional motor drive that connects to an intermediate DC bus of an energy storage battery, either directly, or through a DC/DC converter.

In some embodiments, the series converter and/or the shunt converter comprises 2-level/3-level voltage source converters (VSC) or modular multilevel converters (MMCs).

In some embodiments, the series converter is configured via active regulation to absorb instantaneous angle differences to damp oscillations and energy swings between regions in the distribution or transmission system.

In some embodiments, the controller is configured to direct operation of the series converter and the shunt converter through the third stage transformer and the one or more energy storage equipment in grid-forming control (GFM) mode when state-of-charge (SOC) of the one or more energy storage equipment is above a pre-defined threshold, and wherein the controller is configured to direct operation of the series converter and the shunt converter through the third stage transformer and the one or more energy storage equipment in grid-following control (GFL) mode when the state-of-charge (SOC) of the one or more energy storage equipment is below a pre-defined threshold.

In some embodiments, the controller is configured, via the computer readable instructions, to direct the operation of the series converter and the shunt converter to provide the steady-state line power flow at the distribution or transmission transformer for at least one function of: energy/power balance, power flow control, congestion management, asset utilization, VAR/Voltage support, energy storage, or a combination thereof.

In some embodiments, the controller is configured, via the computer readable instructions, to direct the operation of the series converter and the shunt converter to provide the dynamic shunt and series damping to grid transients at the distribution or transmission transformer for at least one function of: damping (series/shunt), stability, protection, fault-recovery, or a combination thereof.

In another aspect, a method is disclosed comprising: retrofitting a distribution or transmission transformer (e.g., a passive three-phase medium or high voltage transformer or three single-phase medium or high voltage transformers) in distribution or transmission infrastructure with a retrofittable fractionally-rated active grid dampening system, by connecting terminals of the retrofittable fractionally-rated active grid dampening system in series to a secondary-side winding of the distribution or transmission transformer, wherein the retrofittable fractionally-rated active grid dampening system comprises: system terminals, including (i) a first input terminal, or a set thereof, and (ii) a second output terminal, or a set thereof, to couple in series to the secondary-side winding of the distribution or transmission transformer (e.g., a passive three-phase medium or high voltage transformer or three single-phase medium or high voltage transformers); a first stage disconnection switch having a disconnection switch device that couples of the first input terminal, or the set thereof, of the system terminals; a second stage conversion and energy storage module coupled to the first stage fail-normal disconnection switch, the second stage conversion and energy storage module comprising a series converter and a shunt converter coupled to one or more energy storage equipment via a DC bus, a third stage transformer comprising a transformer having a first winding side and a second winding side, the first winding side coupled to outputs of the second stage conversion and energy storage module, and the second winding side coupled to the second output terminal or a set thereof; and a controller operatively coupled to the series converter and the shunt converter, the controller being configured, via computer readable instructions, to direct operation of the series converter and the shunt converter through the third stage transformer and the one or more energy storage equipment, as a network transient damper, to (i) control steady-state line power flow at the distribution or transmission transformer and (ii) provide dynamic shunt and series damping to grid transients at the distribution or transmission transformer.

In another aspect, a method of controlling a grid is disclosed comprising: sensing a distribution or transmission transformer via a retrofittable fractionally-rated active grid dampening system, wherein the retrofittable fractionally-rated active grid dampening system includes (i) a conversion and energy storage module coupled comprising a series converter and a shunt converter coupled to one or more energy storage equipment via a DC bus and (ii) a transformer having a first winding side and a second winding side, the first winding side coupled to outputs of the conversion and energy storage module, and the second winding side coupled to a secondary winding of the distribution or transmission transformer; and executing a grid-forming control operation at the retrofittable fractionally-rated active grid dampening system for steady-state regulation (i.e., power flow control, voltage regulation, impedance control, voltage/current balancing, harmonic compensation, etc.) and/or dynamic control (i.e., grid forming capabilities, inertia support, active damping, fault-ride-through, phase jump, etc.) by dynamically provide virtual inertia and damp undesired oscillations through injection of appropriate voltages and currents at fractional power level, via the series converter and shunt converter through the one or more energy storage equipment.

In some embodiments, the retrofittable fractionally-rated active grid dampening system includes a controller configured to perform power-flow control.

In some embodiments, the controller of the retrofittable fractionally-rated active grid dampening system is configured to perform voltage regulation control.

In some embodiments, the controller of the retrofittable fractionally-rated active grid dampening system is configured to perform impedance control.

In some embodiments, the retrofittable fractionally-rated active grid dampening system includes a dynamic controller configured for at least one of grid-forming operation, inertia support, active damping, fault and phase jumps, or a combination thereof.

In some embodiments, the series converter is configured, via active regulation, to absorb instantaneous angle differences, via control of the series converter and the shunt converter in regulating power to the one or more energy storage equipment, to damp oscillations and energy swings between regions in a distribution or transmission system of the distribution or transmission transformer.

In some embodiments, a controller of the retrofittable fractionally-rated active grid dampening system is configured to direct operation of the series converter and the shunt converter through the transformer and the one or more energy storage equipment in grid-forming control (GFM) mode when state-of-charge (SOC) of the one or more energy storage equipment is above a pre-defined threshold, and wherein the controller is configured to direct operation of the series converter and the shunt converter through the transformer and the one or more energy storage equipment in grid-following control (GFL) mode when the state-of-charge (SOC) of the one or more energy storage equipment is below a pre-defined threshold.

In some embodiments, the controller is configured, via the computer readable instructions, to direct the operation of the series converter and the shunt converter to provide the steady-state line power flow at the distribution or transmission transformer for at least one function of: energy/power balance, power flow control, congestion management, asset utilization, VAR/Voltage support, energy storage, or a combination thereof.

In some embodiments, the controller is configured, via the computer readable instructions, to direct the operation of the series converter and the shunt converter, to provide the dynamic shunt and series damping to grid transients at the distribution or transmission transformer for at least one function of: damping (series/shunt), stability, protection, fault-recovery, or a combination thereof.

In some embodiments, the first-stage disconnection switch is configured to bypass the second-stage conversion and energy storage module during a detected fault event associated with the second-stage conversion and energy storage module.

In another aspect, a method of controlling a grid is disclosed comprising: sensing a distribution or transmission having via a fractionally-rated active grid dampening module, wherein the retrofittable fractionally-rated active grid dampening module includes (i) a conversion and energy storage module coupled comprising a series converter and a shunt converter coupled to one or more energy storage equipment via a DC bus and (ii) a transformer having a first winding side and a second winding side, the first winding side coupled to outputs of the conversion and energy storage module, and the second winding side coupled to a secondary winding of the distribution or transmission transformer; and executing a grid-forming control operation at the fractionally-rated active grid dampening module for steady-state regulation (i.e., power flow control, voltage regulation, impedance control, voltage/current balancing, harmonic compensation, etc.) and/or dynamic control (i.e., grid forming capabilities, inertia support, active damping, fault-ride-through, phase jump, etc.) by dynamically provide virtual inertia and damp undesired oscillations through injection of appropriate voltages and currents at fractional power level, via the series converter and shunt converter through the one or more energy storage equipment.

### BRIEF DESCRIPTION OF THE DRAWINGS

FIGS. 1A and 1B each shows an exemplary fractionally-rated active grid dampening system configured to be deployed at the distribution or transmission level in accordance with an illustrative embodiment.

FIGS. 2A-2D show example methods to retrofit a fractionally-rated active grid dampening system to a passive high-voltage transformer in accordance with an illustrative embodiment.

FIGS. 3A and 3B show the grid-forming operation mode of the shunt converter and series converter of the fractionally-rated active grid dampening system in accordance with an illustrative embodiment.

FIGS. 3C and 3D show the grid-following operation mode of the tertiary-side converter and line-side converter of the fractionally-rated active grid dampening system in accordance with an illustrative embodiment.

FIGS. 4A-4C shows simulation results of a transient case study of the fractionally-rated active grid dampening system in accordance with an illustrative embodiment.

FIGS. 5A-5C shows simulation results of a power oscillation study of the fractionally-rated active grid dampening system in accordance with an illustrative embodiment.

FIGS. 6A-6C show simulation results of an inverter-low-voltage and short-circuit ride through operation of the fractionally-rated active grid dampening system in accordance with an illustrative embodiment.

FIGS. 7A-7C show the black-start operation of the fractionally-rated active grid dampening system in accordance with an illustrative embodiment.

FIG. 8 shows hardware-in-the-loop results of the operation of the fractionally-rated active grid dampening system for a set of test scenarios in accordance with an illustrative embodiment.

FIGS. 9A-9D show an example design of the fractionally-rated active grid dampening system in accordance with an illustrative embodiment.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED SPECIFICATION

To facilitate an understanding of the principles and features of various embodiments of the present invention, they are explained hereinafter with reference to their implementation in illustrative embodiments.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entireties and to the same extent as if each reference was individually incorporated by reference.

### Example System

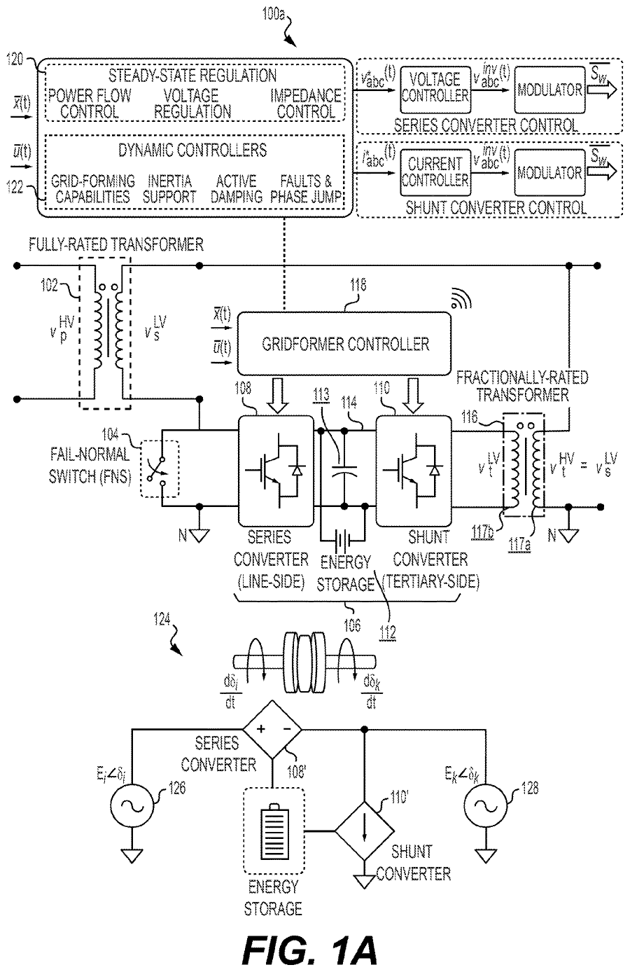

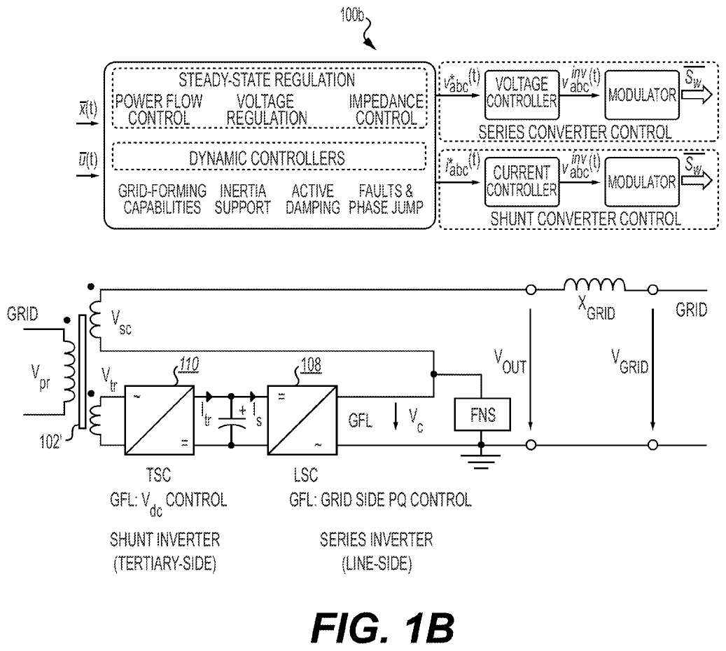

FIGS. 1A and 1B each shows an exemplary fractionally-rated active grid dampening system 100 (shown as 100a, 100b, respectively), also referred to herein as “GridFormer” device, that is configured to be deployed at the distribution or transmission level in accordance with an illustrative embodiment. FIG. 1A shows the fractionally-rated active grid dampening system 100a coupled to a transformer 102 (e.g., Y-Y transformer or A-Y transformer). FIG. 1B shows the fractionally-rated active grid dampening system 100a coupled to a transformer 102′ with an auxiliary winding. The transformer 102′ would be an example of a new type of transformer topology to which the fractionally-rated active grid dampening system 102b is coupled. The transformer of 102 of FIG. 1A could also be fabricated as a new transformer with the fractionally-rated active grid dampening system 100a.

At the distribution or transmission level, the fractionally-rated active grid dampening system 100 (e.g., 100a, 100b) can effect controls (e.g., provide (i) steady-state voltage, impedance, VARs, power flow control, congestion management capabilities, (ii) Grid forming capability, including inertial support, improving grid stability, (iii) Series and parallel damping of oscillations and interactions; (iv) multi-vendor inverters utilization without need grid interactions; and (v) black-start capability) at the distribution or transmission equipment that could cause instability in the distribution or transmission grid or would be expensive and complex to address via new transformers, VAR controllers, or additional energy storage.

Standard kVA to MVA Components. To allow for quick deployment of the solution, the fractionally-rated active grid dampening system 100 (e.g., 100a, 100b) is preferably implemented using low-cost standard building blocks that are available as today's products designed to attach to passive three-phase or three single-phase transformers 102 with rated power from dozens of kVA to hundreds of VA. The fractionally-rated active grid dampening system 100 (e.g., 100a, 100b) can be built, e.g., into a container and shipped and installed at a substation.

Fractionally-Rated Components Architecture. As shown in the example of FIG. 1A, the fractionally-rated active grid dampening system 100 (e.g., 100a, 100b) includes a first-stage disconnection switch having a disconnection switch device 104 (shown as a “fail-normal-switch (FNS)” 104), a second-stage conversion and energy storage module 106 comprising a series converter 108 and a shunt converter 110 coupled to one or more energy storage equipment 112 via an intermediate DC bus 114, a third stage transformer comprising a transformer 116, and a controller 118 (shown as “Grid-forming controller” 118).

The disconnection switch device 104 couples of the first input terminal 106, or the set thereof, of the system terminals. The high-voltage (HV) winding 117a of the partially-rated transformer 116 (e.g., rated at 6-8%) is connected in shunt to one of the windings of the main transformer 102, whereas its low-voltage (LV) winding 117b serves as the input for the shunt power converter 110. The fractionally-rated active grid dampening system 100 (e.g., 100a, 100b) is equipped with a fail-normal switch (FNS) 104 configured to bypass the series power converter 108 and allow the main transformer 102 to ride any fault in the system based on its inherent physical properties without any power converter intervention. As a result, the fractionally-rated active grid dampening system 100 (e.g., 100a, 100b) is compatible with current grid protection devices and grid reliability standards.

The second stage conversion and energy storage module 106 is coupled to the first stage fail-normal disconnection switch 104 and includes a partially/fractionally-rated series converter 108 and a partially/fractionally-rated shunt converter 110 coupled to one or more energy storage equipment 112 via a DC bus 114. Both the shunt and series power converters (108, 110) are connected in a back-to-back converter topology with additional energy storage 112 in the DC link 114. In each of FIG. 1A and FIG. 1B, the series converter 108 is connected to the line-side of the transformer 102, and the shunt converter 110 is connected to the tertiary side of the transformer 102.

A voltage source converter (VSC) is shown here as an example. Moreover, the internal topology of each converter is based on well-established commercial inverter technologies, such as 2-level/3-level VSCs, or modular multilevel converters (MMCs), depending on the desired voltage and power rating. For example, a 5-MVA, 24-kV/12-kV GridFormer could be realized with a 400-kVA converter with

$${v}_{t}^{L V} = 1 - kV .$$

Alternatively, a 50 MW 230-kV/69-kV GridFormer could be realized with a 3 MW converter using an MMC converter with 4.2-kV AC injection.

The DC-link 114 includes an energy buffer DC-link capacitor 113 and the energy storage source 112 (e.g., battery pack) to enable the active series/shunt damping of grid oscillations, provide black-start capability, and grid-forming functionality (including inertia support and grid stability enhancements).

The third stage transformer 116 is a partially rated transformer. The third stage transformer 116 has a first winding side and a second winding side. The first winding side is coupled to the outputs of the second stage conversion and energy storage module, and the second winding side is coupled to the second output terminal or a set thereof.

The controller 118 is operatively coupled to the series converter and the shunt converter, the controller being configured, via computer readable instructions, to direct operation of the series converter and the shunt converter through the third stage transformer and the one or more energy storage equipment, as a network transient damper, to (i) control steady-state line power flow and voltages at the distribution or transmission transformer, and (ii) provide dynamic shunt and series damping to grid transients at the distribution or transmission transformer (e.g., to provide inertial support and grid forming capability to support the distribution or transmission system).

Grid-Forming Operation. The fractionally-rated active grid dampening system 100 (e.g., 100a, 100b) is configured to provide grid-forming (GFM) operations. Contrary to GFL-only converters, Grid-Forming (GFM) operations provide a controller structure for IBR that can include voltage regulation, virtual inertia/damping, and current limiting [3′] that can provide enhanced transient and small-signal stability margins when compared to GFL converters.

The fractionally-rated active grid dampening system 100 (e.g., 100a, 100b) can provide stabilizing effects as GFM controllers that implement GFM control loops and their functionality uniquely in a series-shunt fashion. FIGS. 1A and 1B show the fractionally-rated active grid dampening system 100a, 100b providing a set of cascaded voltage and current loops (shown as “Steady-State Regulation” 120 and “Dynamic Controllers” 122) that can be used by the series and shunt converters (108, 110) to provide steady-state regulation (i.e., power flow control, voltage regulation, impedance control, voltage/current balancing, harmonic compensation), as well as dynamic control (i.e., grid forming capabilities, inertia support, active damping, fault-ride-through, phase jump, among others). In addition, using its series and shunt converters (108, 110), the fractionally-rated active grid dampening system 100 (e.g., 100a, 100b) can dynamically provide virtual inertia and damp undesired oscillations by injecting the appropriate voltages and currents at fractional power levels. This is in contrast with conventional GFM controllers that use shunt-connected inverters that are connected to distributed energy resources (e.g., PV solar or batteries) to provide the functionality desired.

The fractionally-rated active grid dampening system 100 (e.g., 100a, 100b) is configured to provide steady-state functionality, such as control of power flows in a meshed system to avoid congestion and volt-VAR control. By providing points on the power system where the grid forming and damping function is enabled, it also helps to decouple regions and clusters of IBRs, thus minimizing interactions and assuring stability. By achieving stable grid operation without requiring utility customer-owned inverters to implement constantly shifting technical standards and requirements, the fractionally-rated active grid dampening system 100 (e.g., 100a, 100b) can allow inverters from multiple inverters to operate with the increased level of IBR penetration. While the exact required percentage of GFM IBRs depends on the characteristics of the system being evaluated, in general, 10-30% of the total IBRs is adequate [4′].

To damp oscillations and energy swings between regions in the system (see diagram 124, FIG. 1A), the system of the grid may require a substantial level of energy exchange and damping from the shunt inverters. By way of contrast, the fractionally-rated active grid dampening system 100 (e.g., 100a, 100b) can dynamically act to prevent the exchange of energy between the regions by allowing the series inverter 108 (shown as 108′) to absorb the instantaneous angle differences 126 without the exchange of much energy. This operation principle resembles the functionality of a mechanical “clutch,” which, in its simplest implementation, can dampen the torque oscillations of two rotating discs while dissipating the required energy to smooth the power transfer. Furthermore, the shunt converter 110 (shown as 110′) can also absorb energy 128 to provide damping. This is a functionality that is not possible with traditional shunt IBR devices and can only be achieved with a series-shunt converter (108, 110) with the instant controller 118.

Indeed, the fractionally-rated active grid dampening system 100 (e.g., 100a, 100b) can aid in the transition to the future IBR-rich grid by allowing the ad-hoc deployment of IBR without the need for detailed system modeling, lengthy interconnections studies, and close IBR-operation monitoring by the grid operators.

### Example Retrofit Operation

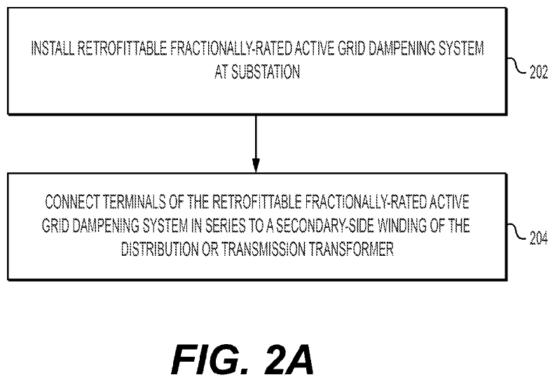

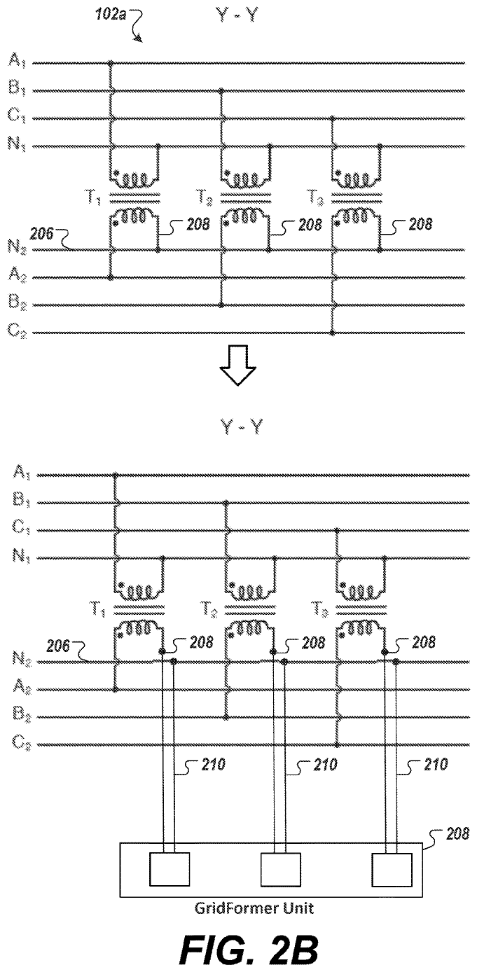

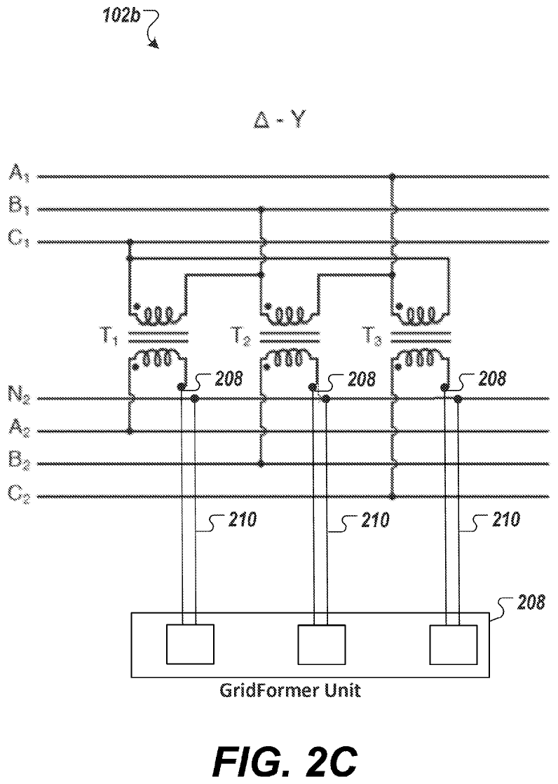

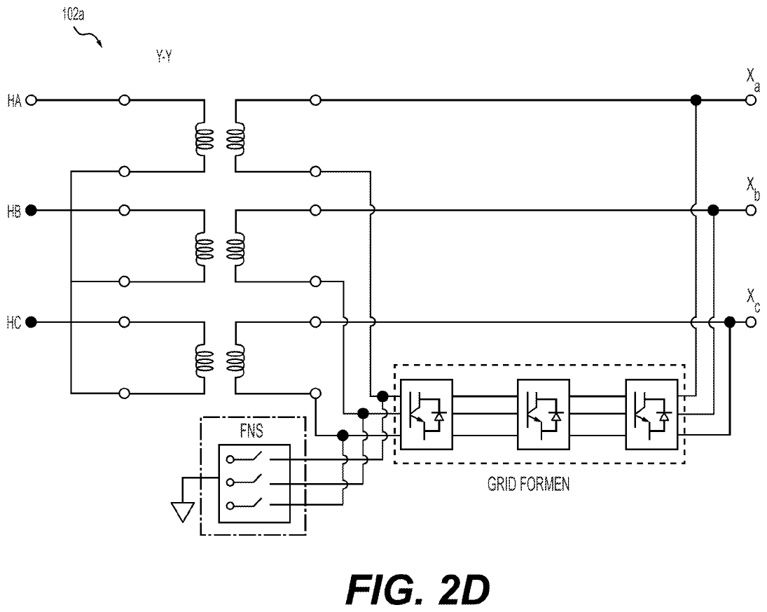

FIG. 2A shows an example method 200 to retrofit a fractionally-rated active grid dampening system 100 to a passive high voltage transformer.

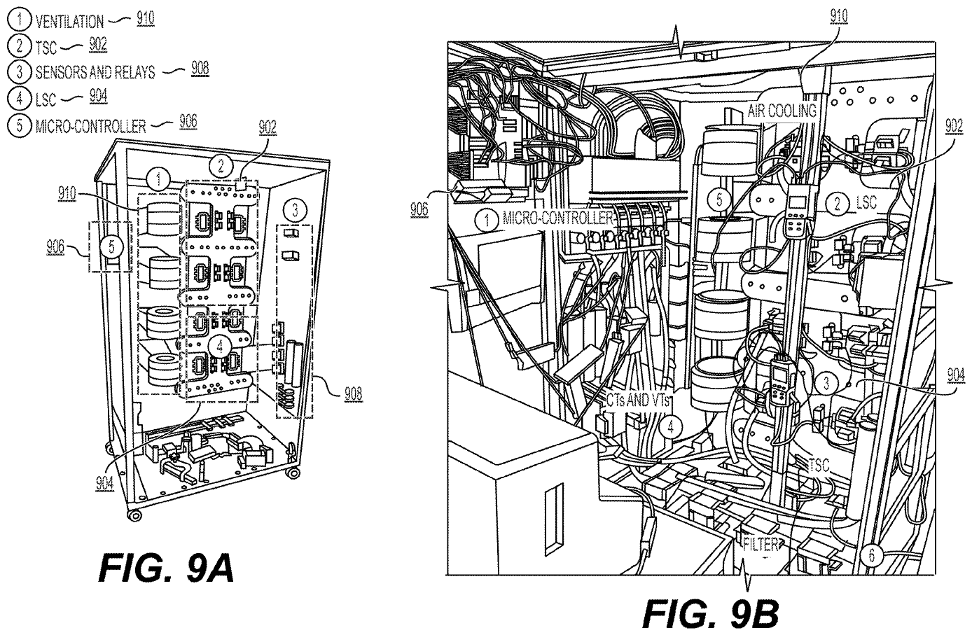

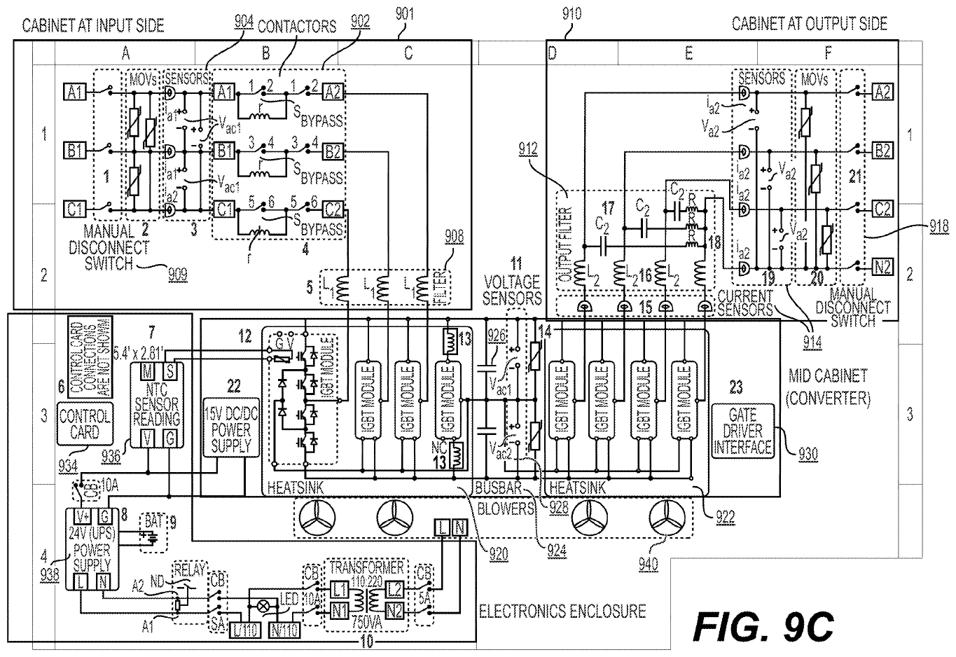

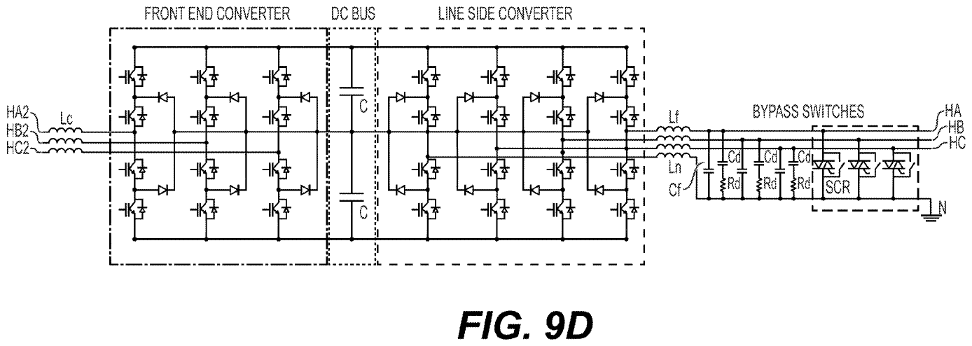

In FIG. 2A, method 200 includes installing (202) the retrofittable fractionally-rated active grid dampening system 100 (e.g., 100a, 100b) at a substation. FIGS. 9A-9D show an example cabinet system housing the fractionally-rated active grid dampening system 100 (e.g., 100a, 100b) that can be installed at a substation. Concurrent with the installation, wiring between the fractionally-rated active grid dampening system 100 (e.g., 100a, 100b) can be routed between the substation unit and the transformer.

Method 200 then includes connecting terminals of the retrofittable fractionally-rated active grid dampening system 100 (e.g., 100a, 100b) in series to a secondary-side winding of the distribution or transmission transformer. FIGS. 2B-2D show example connections for the different passive high voltage transformer configurations.

FIG. 2B shows the main transformer 102 (shown as 102a) is configured as a Y-Y configuration with 2 terminals for each winding. FIG. 2C shows the main transformer 102 (shown as 102b) is configured as a A-Y configuration with 2 terminals for each winding. In each of FIGS. 2B and 2C, the retrofittable fractionally-rated active grid dampening system 100 (shown as systems 208) is connected in series connection to the neutral side 206 of the winding, which is normally grounded. The existing transformer winding may be opened up so that the fail-normal switch can be inserted between the neutral terminal and ground. A similar connection can be applied for the 3-terminal windings as shown in FIG. 1B. As shown in FIG. 2B, the neutral connection of the transformer 102a, 102b is first disconnected from the neutral line 206. The grid-forming unit 208 is then connected at its input to the neutral connection 208 of the transformer 102a, 102b and the return 210 to the neural line 206. FIG. 2D shows an example connection, e.g., for transformer 102a or 102b.

### Example Method of Operation

As discussed above, rather than employing a new three-winding transformer, for example compared to alternative hardware such as an MCT [6′], [7′], the fractionally-rated active grid dampening system 100 (e.g., 100a, 100b) is coupled to a series-connected fully rated line transformer (an existing asset), and only adds, as further described below, a shunt-connected fractionally rated transformer and back-to-back (B2B) converters (108, 110) as a building block. This retrofits the line transformer, allowing for the use of existing equipment, thus reducing the cost of achieving new grid support functions needed at such line transformers.

In addition, to actively inject active power into the grid, the fractionally-rated active grid dampening system 100 (e.g., 100a, 100b) connects an energy storage device 112 to the DC link 114 of the B2B converters (108, 110) to decouple the power flow between (i) the series converter 108 as line-side converter (LSC) and (ii) the shunt converter 110 as the tertiary-side converter (TSC). Thus, both converters (108, 110) can inject grid-supporting power up to the fractional rating in a transient event.

Further, instead of operating in a gird-following (GFL) mode, the fractionally-rated active grid dampening system 100 (e.g., 100a, 100b) can operate the tertiary-side converter (e.g., shunt converter 110) in a grid forming mode, which, because of its voltage source characteristic, the tertiary-side converter can instantaneously change its output power, providing faster grid support in transient events.

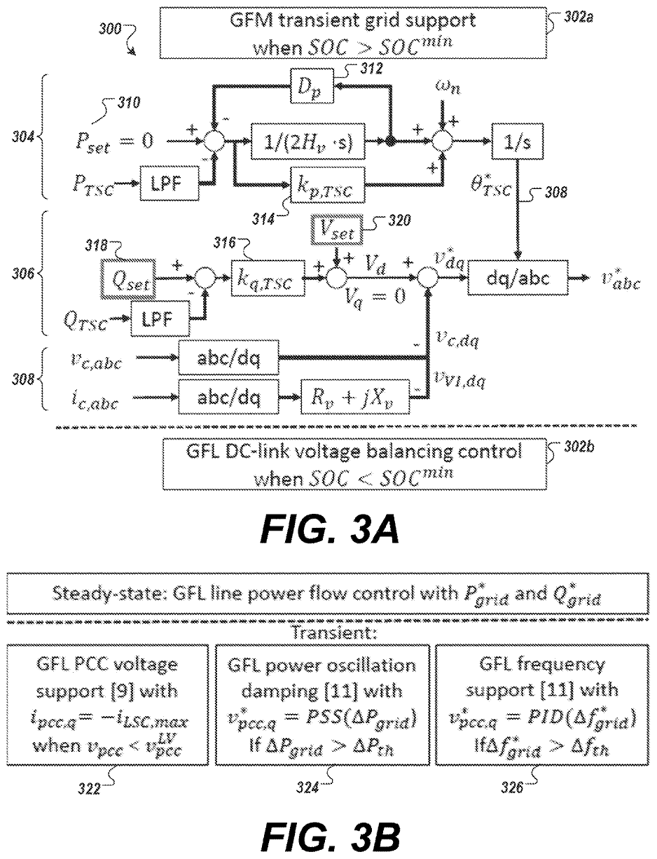

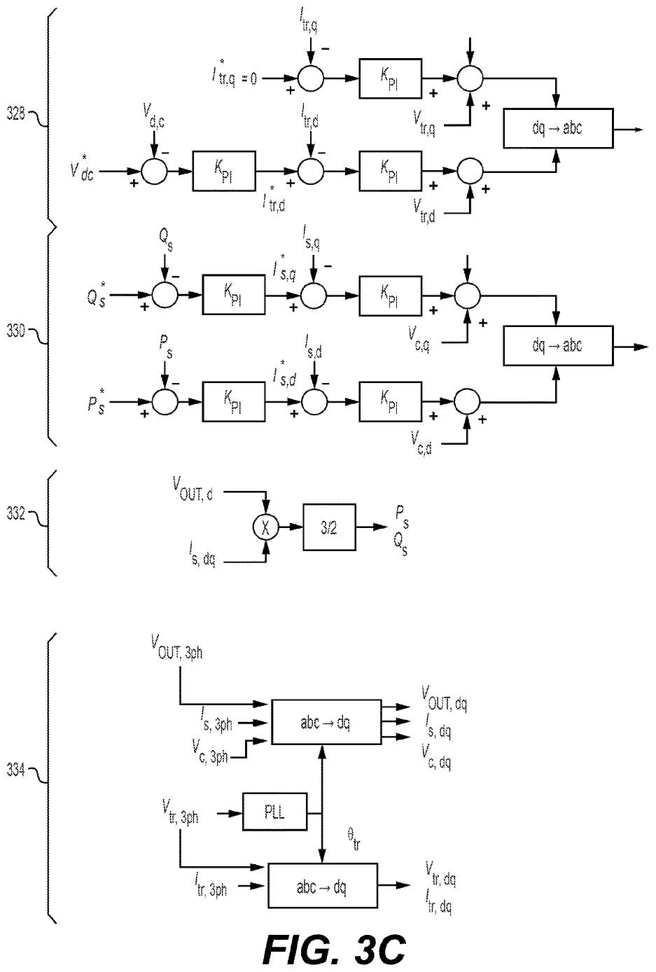

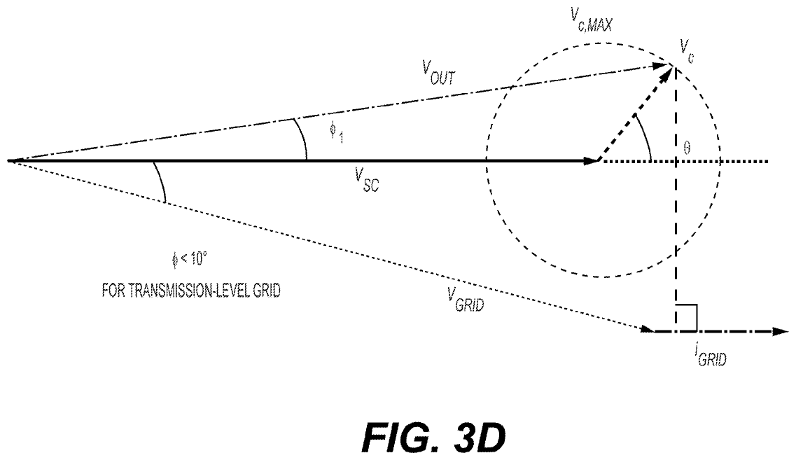

FIG. 3A shows the operation mode of the tertiary-side converter (TSC) (e.g., 110). The controller (e.g., 118) is configured to assess (302a, 302b) when the state-of-charge (SOC) of the energy storage (e.g., 112) is higher than the minimal threshold in which the TSC (e.g., 108) can provide transient grid support in GFM mode (302a). Otherwise, the TSC (e.g., 108) would operate in the GFL mode (302b), allowing the grid to charge the energy storage (e.g., 112). Depending on the frequency and the time interval of the grid transients, the energy storage (e.g., 112) can be configured to operate for a couple of minutes or a couple of hours. It is assumed that the grid can charge the energy storage (e.g., 112) in a relatively short time so that the TSC (e.g., 110) primarily operates in the GFM grid-supporting mode.

Referring still to FIG. 3A, the GFM mode 300 includes Power synchronization control (PSC) 302, Reactive power control (RPC) 304, and Current-limiting virtual-impedance control (VI) 306.

Power synchronization control (PSC) 304 can help recover the frequency in case of an inter/intra power oscillation or load step change. In the example shown in FIG. 3, PSC (302) is configured to emulate the inverter as a virtual synchronous generator (VSG) with a virtual inertia constant Hᵥ, damping coefficient Dₚ and droop k_{p,TSC} [9]. The output of PSC (302) is the reference phase angle

$${θ}_{T S C}^{*} ( 308 ) .$$

The active power set point Pₛₑₜ (310) can be set to zero because the TSC (e.g., 110) only provides power in grid transients, not in steady-state. Dₚ (312) can be set as the inverse of k_{p,TSC} (314), and k_{p,sys} can be set with the power system droop k_{p,sys}, the full power system rating S_{sys} and the TSC power rating S_{TSC}, per Equation 1.

$${k}_{p , TSC} = {k}_{p , sys} \cdot \frac{{S}_{s y s}}{{S}_{TSC}} \qquad ( Eq . 1 )$$

Reactive power control (RPC) (306) is configured to determine the reference magnitude of the point-of-common-coupling (PCC) voltage. In the example shown in FIG. 3, the droop gain k_{p,TSC} (316) is determined similarly to Equation 1. In RPC, the reactive power set point Qₛₑₜ (318) and the voltage magnitude set point Vₛₑₜ (320) are two variables that depend on the current grid condition.

In a first condition, if the magnitude of the PCC voltage v_{pcc} is lower than the threshold

$${v}_{p c c}^{b o} ,$$

say 0.1 pu as an example, the controller can establish that the grid is currently in a black-out state in which all the generators and loads are disconnected, and the main grid is down. The TSC (e.g., 110) can then be used to form an initial voltage and provide initial power for the black-start. In this case, Qₛₑₜ (318) is set to “0,” and Vₛₑₜ (320) is set to ramp up from 0 pu to 1 pu.

In a second condition, if v_{pcc} is higher than

$${v}_{p c c}^{b o} ,$$

but lower than another threshold

$${v}_{p c c}^{L V} ,$$

say 0.8 pu as an example, the controller 300 can establish that the grid currently has a voltage dip (or short-circuit in an extreme case). The TSC (e.g., 110) can inject reactive power and assist with PCC voltage recovery. In this case, Qₛₑₜ (318) is set to the TSC maximal converter rating S_{TSC}, and Vₛₑₜ (320) is set to 1 pu. In case of an overshoot in v_{pcc}, say 1.2 pu as an example, Qₛₑₜ (318) is set to −S_{TSC}.

Otherwise (to the first and second condition), the controller 300 can establish the grid voltage as normal and Qₛₑₜ (318) is set to 0 to provide Volt-VAR sweeping.

The current-limiting virtual-impedance control (VI) (308) is configured to limit the TSC output current by emulating the voltage drop above an impedance as a compensation term. Since the TSC (e.g., 110) is connected in shunt with the grid, v_{pcc} is similar to the grid voltage v_{grid}, while the current i_{pcc} is a fraction of the grid current i_{grid}. Thus, the GFM can control with (i) v_{pcc} as the injecting point and (ii) v_{grid} as the reference point is well-defined.

In the line-side converter (LSC) (e.g., 108), v_{pcc} is only a fractionally rated voltage compared to v_{grid}, while i_{pcc} is the same as i_{grid}. In this case, the GFM control is not well-defined on the LSC since the injecting point is v_{pcc}, and the reference point is the ground. Hence, the LSC can be directed to remain in GFL mode, the same as the existing MCT concept.

FIG. 3B shows examples of GFL operation modes. As shown in FIG. 3B, while the LSC in an MCT only provides steady-state line power flow control capability, the LSC (e.g., 108) can provide three transient grid-supporting functionalities (322, 324, 326). In grid supporting function #1 (322), if v_{pcc} is lower than

$${v}_{p c c}^{L V} ,$$

the LSC (e.g., 108) is configured to inject a maximal negative inverter current to help raise v_{pcc} per Equation 2.

$${i}_{p c c , q} = - {i}_{LCS , max} \qquad ( Eq . 2 )$$

In grid supporting function #2 (324), in case there is power oscillation in the system, where the deviation of the line active power from the reference value is larger than a threshold ΔP_{grid}, the LSC (e.g., 108) is configured to inject series q-voltage similar to a power system stabilizer (PSS) in a synchronous generator (SG) to help damp the power oscillation [11] per Equation 3.

$${v}_{p c c , q}^{*} = PSS ( Δ Pgrid ) \qquad ( Eq . 3 )$$

In grid-supporting function #3 (326), in case the PLL detects a frequency over- or undershoot, where the deviation from the reference frequency is higher than a threshold, the LSC (e.g., 108) is configured to inject series q-voltage as a PID function of the frequency deviation [11] per Equation 4.

$${v}_{p c c , q}^{*} = PID ( Δ {f}_{g r i d}^{*} ) \qquad ( Eq . 4 )$$

The fractionally rated LSC (e.g., 108) can apply the same control schemes in grid transients. In these three transient modes, the LSC (e.g., 108) would not have power control capability since a small change in v_{pcc} can cause a large change in i_{pcc}, as well as in the power flow. On the contrary, when the TSC (e.g., 110) injects fractional current in shunt with the main line, a small change in v_{pcc} can cause a small change in i_{pcc}, as well as a small change in the power flow. In other words, transient damping using the TSC (e.g., 110) does not conflict with the transactive power flow control objective. Hence, it is preferred to use the TSC (e.g., 110) to damp the grid transients. The LSC (e.g., 108) damping is only active if the priority to damp the grid transient is higher than the transactive goal.

FIG. 3C shows examples of GFL modes. Specifically, FIG. 3C shows the power flow control scheme of the GridFormer controller 118 (similar to that of the MCT) when operating in grid-following mode operation, including for DC link voltage balancing control (328); Active/Reactive power flow control (330); Output power estimation (332); and PLL and abc-dq transformation (334).

FIG. 3D shows a voltage vector diagram for the operation of the GridFormer controller 118 in grid-following mode operation. The output of the LSC V_{c} and the secondary-side voltage V_{sc} form the sending end voltage Vₒᵤₜ. Along with the receiving end grid voltage V_{grid} and the grid impedance X_{grid}, the power transmission can be determined [6].

By changing the length and the angle θ of V_{c}, the length and the angle of the grid current i_{grid} can be respectively controlled, which corresponds to an accurate active and reactive power flow control. Since the phase angle φ between Vsc and Vgrid is smaller than 10° for a transmission grid, it is proven in [6] that the TSC (e.g., 110) and LSC (e.g., 108) only need to be rated at 5~10% of the full power rating to control the full range line power flow.

In the distribution grid, where φ could be larger than 10°, the power rating of TSC and LSC would be increased accordingly to have the same controllability. Different from the UPFC, the converter (e.g., 108, 110) neutral point does not float with the line voltage, since V_{sc} shares the majority part of Vₒᵤₜ. The neutral point can be safely grounded, which reduces the isolation requirement of the converter. This also enables high scalability of the inverter power rating, allowing a wider power flow control range.

Further description of the grid-follower operation is provided in Yan, Benzaquen, and Divan, “‘Grid Former’—An Active Grid-Controlling Device with Dynamic Grid-Support Functionality,” which is incorporated by reference herein in its entirety.

### Example Method

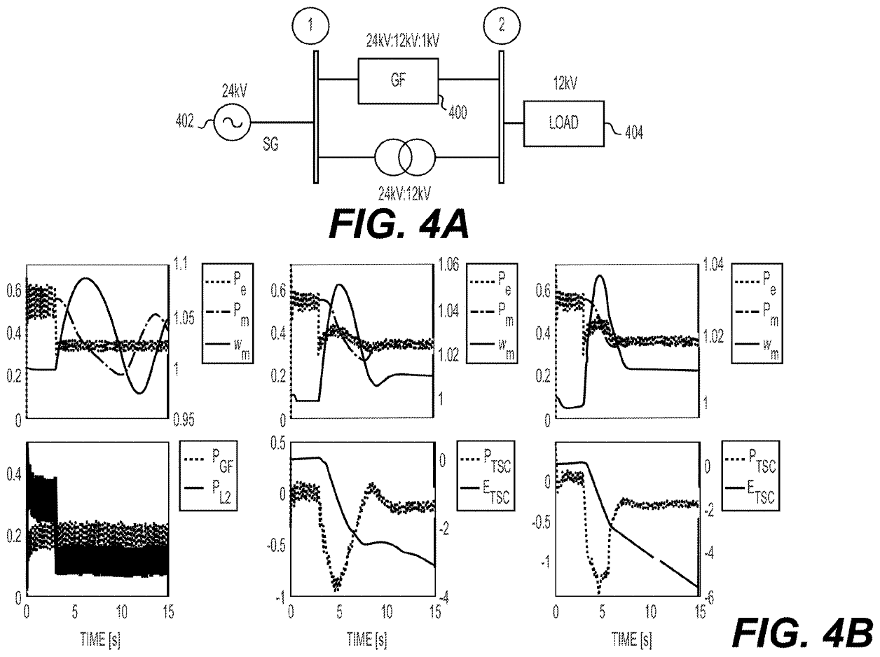

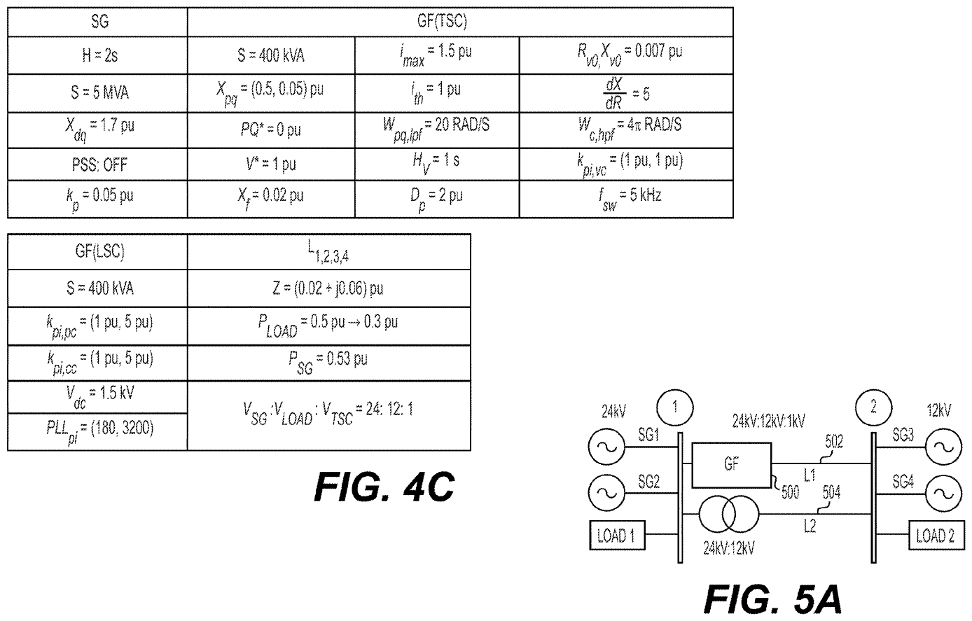

Case Study #1: Frequency support after a load step change. FIGS. 4A-4C shows a transient case study for frequency support on a simple single-bus single-load system where a 24 kV synchronous generator (SG) (402) interfaces with a 12-kV load (404) through two parallel lines in which a fractionally-rated active grid dampening system 100 (shown as “GF” 400) is connected at the terminal of one line to control its steady-state power flow. The line-line voltage terminal of the TSC (e.g., 110) of the system 400 is 1 kV. FIG. 4B shows the simulation results, and FIG. 4C shows a table with the parameters of the power system.

As shown in FIG. 4B, the load decreases by 0.2 pu at 3 s. Without power injection from the system 400, the APC and AVR of the SG are the only two units that help recover the frequency by converging the mechanical input power P_{mech} to the electrical output power Pₑ. The swing equation of the SG without the “Grid Former” is described as

$${J}_{S G} \frac{d {w}_{S G}}{dt} = {P}_{m e c h} - {P}_{e} = {P}_{m e c h} - {P}_{l o a d}$$

with the SG inertia, rotational frequency, and load power denoted as J_{SG}, ω_{SG}, and P_{load}.

However, due to the large time constant of the electro-mechanical control loop, this frequency balancing usually takes multiple seconds or minutes, which can cause a relatively large frequency over/under-shoot that potentially trips the loads and IBRs interconnected to the system. Hence, as described in the control operation in relation to FIG. 3A, after a load step change, the fractionally-rated active grid dampening system 400 can transiently provide fractional active power and help converge Pₑ to P_{mech} to shorten the time constant to milliseconds. The swing equation of the SG with the fractionally-rated active grid dampening system 400 is shown per Equation 5 with an additional term of the “Grid Former” power injection denoted as PGF.

$${J}_{S G} \frac{d {w}_{SG}}{d t} = {P}_{m e c h} - {P}_{e} = {P}_{m e c h} - {P}_{l o a d} - {P}_{G F} \qquad ( 5 )$$

The TSC (e.g., 110) can provide transient active power, while the LSC (e.g., 108) can keep regulating steady-state line power flow. Since the GFM droop gain parameter affects the TSC output power, FIG. 4B shows a comparison of three cases: (i) TSC disabled (baseline) (ii) TSC enabled with the active power droop gain k_{p,TSC}=0.5 pu (iii) TSC enabled with k_{p,TSC}=0.2 pu.

As shown in FIG. 4B, the frequency overshoots in all three cases are respectively 10%, 5% and 3.5%, proving that the GFM-controlled TSC (e.g., 110) does help damp the frequency deviation. The presented values depend on the specific SG and TSC parameters. Indeed, FIG. 4B shows an incremental qualitative benefit of the “Grid Former” 400. Case study #2 with higher k_{p,TSC} exhibits less power support and, therefore, slightly higher frequency overshoot than Case Study #3. However, Case Study #3 requires more energy from the storage unit to balance the frequency. Furthermore, Case Study #3 ends up with a higher steady-state output power that continuously drains the storage.

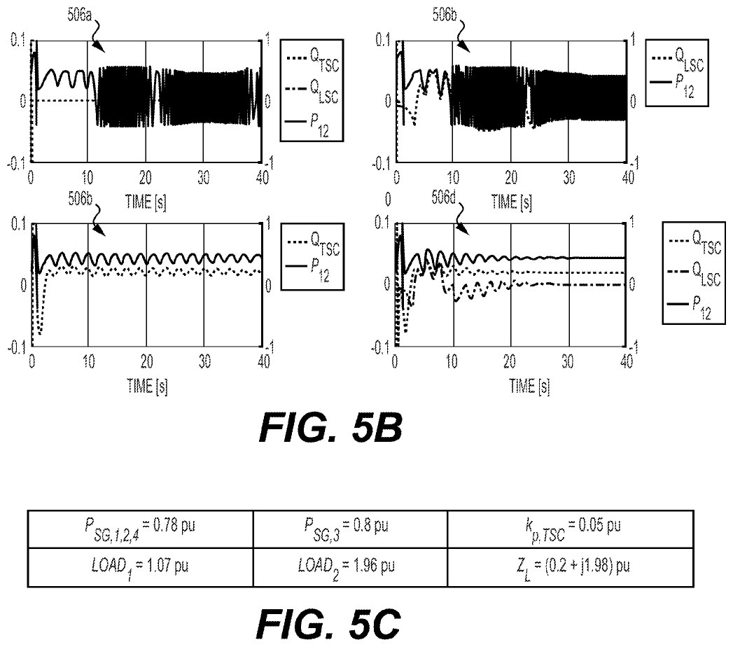

Case Study #2: Power oscillation damping (POD). FIGS. 5A-5C shows power oscillation study on a four-bus, two-area power system model [3]. FIG. 5B shows the simulation results, and FIG. 5C shows a table with the parameters of the power system.

As shown in FIG. 5A, this model has two parallel connected lines (502, 504) between the two areas. The power oscillation is triggered by disconnecting line L2 (504) instantaneously from normal operation. A fractionally-rated active grid dampening system 100 (shown as “GF” 500) is deployed on line L1 (502) to dampen the power oscillation. The power system stabilizer is not activated on the SGs. The simulation compared four cases: (i) without POD (baseline) (506a), (ii) POD using GFL-LSC (506b), (iii) POD using GFM-TSC (506c), and (iv) POD using both GFM-TSC and GFL-LSC (506d).

FIG. 5B shows respectively the reactive power of TSC Q_{TSC}, the reactive power of LSC Q_{LSC}, as well as the active power transmission between areas 1 and 2 P₁₂ in case (i)-(iv) (506a, 506b, 506c, 506d). In case (i) (506a) and case(ii) (506b), the active power transmission P₁₂ has a non-damping oscillation between −0.45 pu and 0.45 pu, indicating that the LSC rated at 0.08 pu does not provide sufficient series damping against the 0.9 pu power oscillation. In case (iii) (506c), with only the TSC rated at 0.08 pu, the active power transmission P₁₂ oscillates between 0.2 pu and 0.45 pu. Although the magnitude of 0.25 pu is much less compared to 0.9 pu, proving that the TSC has better POD than the LSC, TSC alone still cannot completely dampen the oscillation. With both TSC (e.g., 110) and LSC (e.g., 108), it is shown in (d) (506d) that the oscillation is fully damped, and the active power transmission P₁₂ is maintained at 0.45 pu. This highlights that the series/shunt damping capability of 0.16 pu is sufficient to damp 0.9 pu power oscillation.

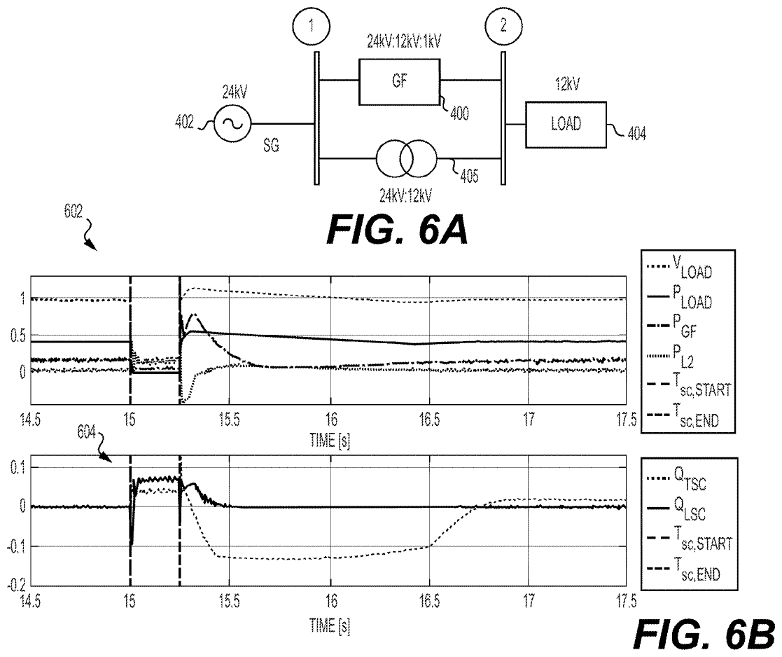

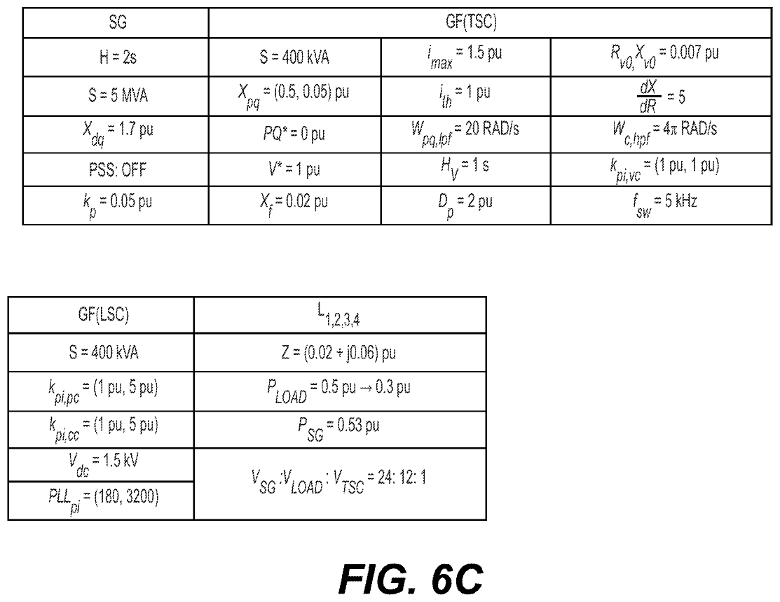

Case Study #3: Inverter low-voltage short-circuit ride-through. FIGS. 6A-6C show an inverter-low-voltage and short-circuit ride-through capability of the fractionally-rated active grid dampening system 100 (e.g., 100a, 100b) in case of line voltage dip or more extremely line-ground short-circuit fault. FIG. 6B shows the simulation results, and FIG. 6C shows a table with the parameters of the power system.

While an MCT would simply bypass the LSC output and trip the converters, the fractionally-rated active grid dampening system 100 (e.g., 100a, 100b) with the TSC (e.g., 110) and LSC (e.g., 108) can inject reactive power to the grid to help form and stabilize the line voltage. The GFM-controlled TSC (e.g., 110) can set the reactive power set point to maximal inverter power rating, while the GFL-controlled LSC (e.g., 108) can set the reactive current reference to negative maximal inverter current rating [9]. The LSC (e.g., 108) can stop to regulate power flow during the fault.

The power system of FIG. 6A is the same as that described in relation to FIG. 4A with the same parameters except that k_{p,TSC}=0.05 pu. Line-ground short circuit fault happens at 15 s on bus 2 (405). The fault clears itself in 15 AC fundamental cycles. The GFM-TSC (e.g., 110) forms a stable voltage that the GFL-LSC (e.g., 108) can track and accordingly inject reactive power. FIG. 6B shows the line and load power flow in plot 602, while plot 604 shows the TSC and LSC reactive power support.

The TSC (e.g., 110) can provide 0.03 pu reactive power while the LSC (e.g., 108) can provide 0.07 pu reactive power to bus 2 (405), proving that LSC (e.g., 108) can provide better reactive power support than TSC (e.g., 110). After the fault, power flow control is recovered, showing that both TSC and LSC control remain stable under the fault.

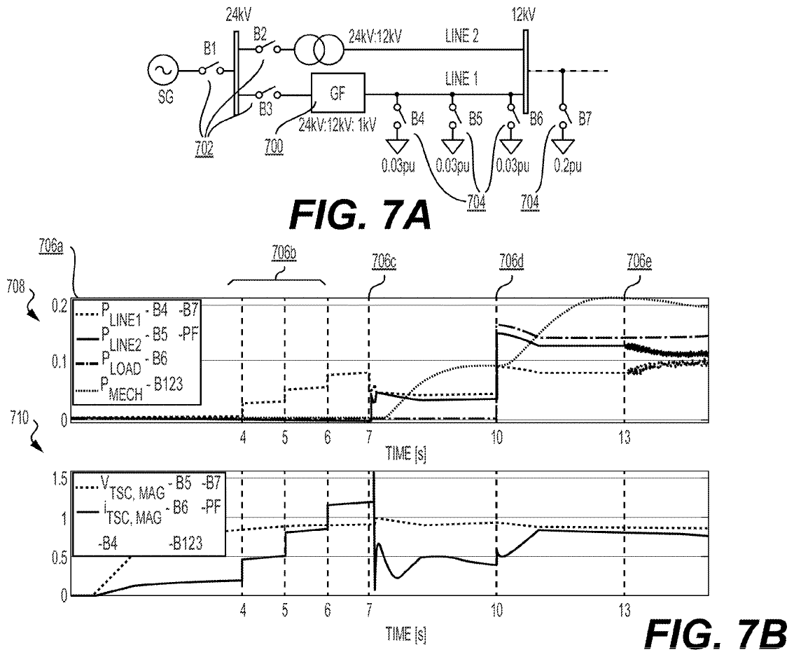

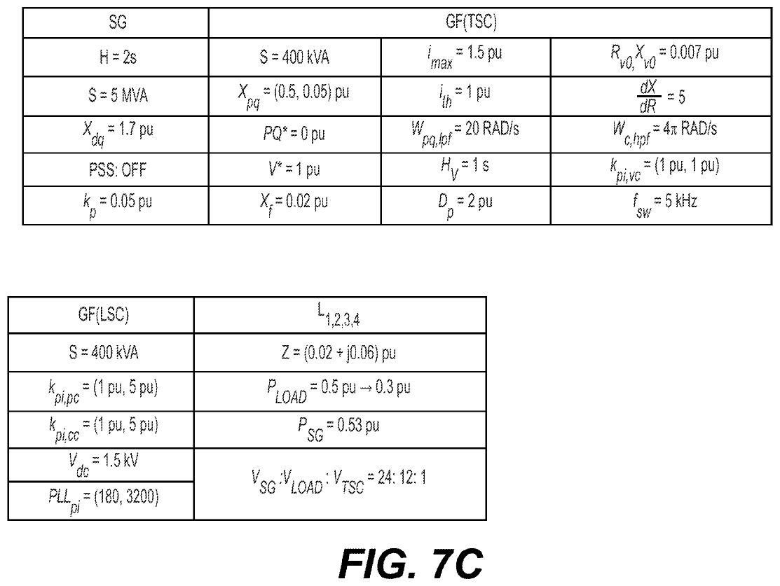

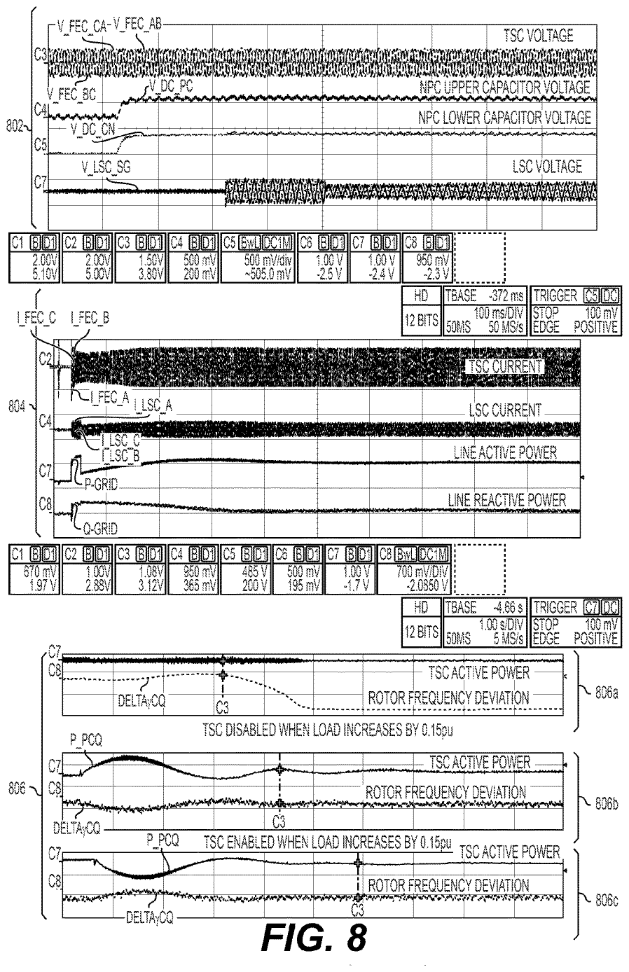

Case study #4: Black-start process. FIGS. 7A-7C show black-start operation for the fractionally-rated active grid dampening system 100 (e.g., 100a, 100b). Existing MCTs do not have grid-forming functionality. In case of a black-out, both TSC and LSC are bypassed and tripped. SGs need to start up and energize the grid, which is time-consuming. This endangers the operation of the uninterruptible power supply (UPS) on the distribution feeder.

In contrast, the fractionally-rated active grid dampening system 100 (shown as “GF” 700) has the GFM-TSC (e.g., 110), which can form the nominal grid voltage for black-start. The energy storage unit (e.g., 114) in the fractionally-rated active grid dampening system 500 can help gradually energize distribution feeders and form a microgrid. With sufficient deployment of the fractionally-rated active grid dampening system 100 (e.g., 100a, 100b), the structured microgrids can be synchronized and connected to the SGs.

The power system of FIG. 7A has the same parameters as that described in FIG. 4A, except that k_{p,TSC}=0.05 pu. The circuit breakers 702 and the distribution feeders 704 are marked in the figure. In the simulation, the black-start procedure for the fractionally-rated active grid dampening system 700 is shown at 5 timesteps.

At time step 706a, at t=0 s, the GFM-TSC (e.g., 110) detects black-out and starts to ramp up Vₛₑₜ from 0 to 1 pu. The GFL-LSC (e.g., 108) is disabled.

At time step 706b, at respectively t=4 seconds, 5 seconds, 6 seconds, the distribution feeders “B4,” “B5,” and “B6” close, and the TSC (e.g., 110) energizes the corresponding 0.03 pu feeders.

At time step 706c, at t=7 s, the circuit breaks “B2” and “B3” closes, recovering Line 2. Meanwhile, the SG accelerates to a nominal speed with nominal voltage but without any load. The circuit breaker “B1” closes whenever the RMS of the voltage difference between the SG voltage and the 24 kV bus voltage is minimal.

At time step 706d, at t=10 s, the distribution feeder “B7” closes. SG ramps up the turbine input power to supply the 0.2 pu feeder on the 12 kV bus.

At time step 706e, at t=13 s, the GFL-LSC is activated, regulating the power flow of Line 1 to 0.1 pu. Black-start is achieved.

FIG. 7B, plot 708 shows the line and load power flow, as well as the SG mechanical input power. FIG. 7B, plot 710 shows the TSC voltage and current magnitude. The waveform validates the step-wise black-start of the feeders using the GFM-TSC and its storage, as well as the recovery of power flow controllability on the GFL-LSC.

### EXPERIMENTAL RESULTS AND ADDITIONAL EXAMPLES

A study was conducted to develop the fractionally rated active grid controlling device (e.g., 100a, 100b) that can control steady-state line power flow, as well as provide dynamic shunt and series damping to different types of grid transients. The concept was based on the existing MCT concept that is essentially a fractionally rated UPFC with enhanced safety, reduced cost and enhanced fault handling capability.

The study set up a HIL simulation platform to test the steady-state power flow control functionality and the transient frequency support after load step change. The HIL included (i) an OP5707 simulator from OPAL-RT that loads the circuit of the “Grid Former”, receives the gating signals from the FPGA, and outputs the scaled analog measurement signals to the FPGA ADC units; (ii) a customized micro-controller with a digital signal processor (DSP) and field-programmable gate array (FPGA). The DSP receives ADC values from the FPGA, runs control code, and outputs duty-cycle to the FPGA. The FPGA runs ADC from the simulator analog output and translates the DSP duty-cycles to switching signals; and (iii) a Labview UI that sends the control mode and reference set point to the controller board, monitors fault condition, as well as visualizes the measurement signals.

FIG. 8 shows the waveform of the “Grid Former” (e.g., 100a, 100b) in the GFL power flow control mode. The circuit running in the simulator included two stiff voltage source of 24 kV and 12 kV interfaced via a “Grid Former”. The topology of the converters (e.g., 108, 110) is neutral-point-clamped (NPC). The upper and lower DC capacitor voltage of the NPC are regulated at 750V, as shown in FIG. 8, plot 802. The line power is regulated at 1 MW active power in a 5MVA system, as shown in FIG. 8, plot 804.

FIG. 8, plot 806 shows the waveform of the “Grid Former” in the load transient damping mode (case study #1). Prior to load transient (806a), the system was balanced with 0.53 pu SG power generation and 0.5 pu load. The “Grid Former” (e.g., 100a, 100b) conducted 0.2 pu active power. When the TSC (e.g., 110) is disabled and the load increases by 0.15 pu (806a), the rotor frequency was decreased to 0, since the SG is not fast enough to balance the load step change. When the TSC (e.g., 110) was enabled and the load increases by 0.15 pu (806b), the rotor frequency has an initial undershoot. Then, the TSC provides active power and damps this undershoot. Similar damping is shown in (806c) when the load decreases by 0.15 pu.

The study is fabricating hardware of the fractionally rated active grid controlling device (e.g., 100a, 100b). FIGS. 9A-9D show an example design of the fractionally rated active grid controlling device (e.g., 100a, 100b). In FIG. 9A, the system 900 includes a tertiary side converter 110 (shown as 902), a line side converter 108 (shown as 904), a micro-controller 118 (shown as 906), associated sensors and relays 908, and ventilation subassembly 910.

FIG. 9B shows the fractionally rated active grid controlling device under state of fabrication. FIG. 9B additionally shows the voltage and current sensors (shown as “VT” and “CT”) and filters.

FIG. 9C shows an example design of the fractionally rated active grid controlling device under state of fabrication. The cabinet at the input side 901 includes the disconnection switch device 104 (shown as contactors 902) as well as sensors 904, metal-oxide varistors (MOV) 906, filters 908, and manual disconnect switch 909. The input side 901 connects in series connection to the neutral side winding of a 3-phase transformer. The existing transformer winding is opened up so that the fail-normal switch can be inserted between the neutral terminal and ground.

The cabinet at the output side 910 includes the partially-rated transformer 116 (shown as output filters 912) as well as current and voltage sensors 914, MOV 916, and manual disconnect switch 918.

The cabinet at the mid-section 920 includes the second stage conversion and energy storage module (e.g., 106) comprising a series converter 108 (shown as 920) and a shunt converter 110 (shown as 922). The converters (920, 922) comprising IGBT modules are connected via busbar 924 to DC link capacitors 926 and energy storage device 118 (shown as 928). The converters (920, 922) include gate driver interface 930. The energy storage 928 may be instrumented with voltage and/or current sensors. FIG. 9D shows an example configuration of the series converter and a shunt converter.

The cabinet at the electronic enclosure 932 includes the GridFormer controller (e.g., 118) (shown as control card 934) as well as sensor reading interface board 936 and power supply 938. The cabinet includes a set of blowers 940 for ventilation.

Indeed, the cabinet can be fabricated using standard build block components, e.g., based on motor driver converters.

### DISCUSSION

Rapidly declining prices of PV solar, wind, and energy storage are leading to massive growth in the penetration of inverter-based resources on the grid. Reductions in the number of synchronous generators and grid-inverter interactions are causing an increasing number of issues on both the transmission and distribution grid. This is also leading to the development of grid-forming (GFM) inverters that can improve the stability of the grid and can also, in principle, help with functions such as black-start and islanded operation. Distributed Energy Resources (DER) sources, and thus the inverters, are not owned by the utilities or directly controlled by grid operators. As a result of hundreds of inverter manufacturers, lagging standards, and complex certification processes—all of which conflict with fast-moving inverter technologies, we are seeing tremendous confusion in the market. There is a danger that large-scale deployment of inverter-based resources (IBRs) will occur while we still do not have a handle on managing an IBR-rich grid, and it is of great concern to utilities and grid operators everywhere.

There is a need for a utility-owned or controlled resource that can be rapidly deployed at scale and which helps the grid in the transition from today's centralized and dispatchable grid profile to a more distributed and decentralized system. The exemplary ‘GridFormer’ device can be deployed at the distribution or transmission level using low-cost standard building blocks to address several key grid-related operating problems that have been identified: (i) steady-state voltage, impedance, VARs, power flow control, congestion management, (ii) grid forming capability, including inertial support, improving grid stability, (iii) decoupling of interactions between regions, (iv) series and parallel damping of oscillations and interactions, (v) allowing multi-vendor inverters to operate without grid interactions, and (vi) black-start capability.

Steady-state impacts, such as volt-VAR control and power flow control, have been addressed in previous patents and publications [1′]. However, the ability to have a dynamic impact and the ability to manage grids with high IBR penetration requires further improvements. The instant disclosure provides an implementation of the GridFormer hardware that enables the desired control functionality, as well as the control principles that are needed to achieve the same. The exemplary GridFormer functionality can be integrated with a new transformer if desired. However, long delays with the planning and deployment cycles of equipment such as large power transformers (LPT) can make this approach less desirable. Given the large deployment of existing transmission and distribution transformers, the GridFormer can provide the desired functionality in a retrofit approach, where an augmentation of an existing transformer asset can provide the new capability, dramatically accelerating deployment.

With more stringent decarbonization policies [1], reduced system cost of RES [2] and advanced power conversion technology, RES are expected to replace the traditional coal and gas plant, providing clean energy in the future power system. The inverter-based resources (IBR) with dedicated fast-dynamic controls and fast-switching switches have high efficiency and high-power density, substituting the bulky and expensive electromechanical power generation unit that consists of prime mover, turbine, passives, and slow regulator, such as Automatic Voltage Regulator (AVR) and Automatic Power Controller (APC) [3] [4]. Because of their faster grid frequency and voltage regulation capability, millions of IBRs are expected to be installed in the future grid. However, with millions of IBRs, the grid is facing enormous challenges because: (i) IBR has no inertia or low emulated virtual inertia, leading to high rate of change of frequency (ROCOF) and endangering the grid frequency stability [1]; (ii) IBRs, such as solar and wind energy, have high volatility, causing power congestion on critical lines and threatening the power system stability [1]; (iii) IBRs are manufactured using different control schemes with different parameters. The non-transparency of the inverter modeling and the cross-coupled inverter control in different time scales complicates the analysis of the system stability and induces low-frequency oscillations; (iv) compared to an SG-dominated system with a strong inherent series damping, IBRs degrade the system passivity, inducing more high-frequency oscillations; (v) the update of new standards are timely lagging the inverter technology. Millions of IBRs require sophisticated orchestration instructed by new standards. The most recently deployed GFM-controlled microgrids are still running without a worldwide unified standard [12].

Hence, the future power system with high IBR penetration requires more transactive grid services (such as power flow control, voltage compensation and balancing), as well as transient grid support to dampen the low-frequency/high-frequency oscillations and enhance the grid stability. The state-of-the-art power-electronics-based grid-controlling devices includes FACTS (flexible AC transmission system) [5], Static Synchronous Compensator (STATCOM), and Static Synchronous Series Compensator (SSSC).

Static Synchronous Compensator can inject reactive current through the line impedance and hence compensates for the line voltage deviation. Both shunt-connected transformer and converter are rated at least 1 pu. STATCOM with battery storage is called ESTATCOM that is able to inject active power.

Static Synchronous Series Compensator (SSSC) can directly form compensation voltage to damp voltage or frequency disturbances. Both shunt-connected transformer and converter are rated at least 1 pu.

Unified Power Flow Controller (UPFC) that combines STATCOM with SSSC by using a back-to-back (B2B) connected converter structure. Both shunt and series transformer and converter are rated at least 1 pu. UPFC provides both shunt and series voltage compensation, as well as active/reactive power flow control and line impedance shaping control.

Recently, the concept of a modular controllable transformer (MCT) that is based on the UPFC concept has been proposed and advanced in some related work [6] [7]. This concept leverages fractionally rated B2B converters (5~10% full power rating) to control full system power, which significantly reduces the installation and operation costs. The neutral point of the power converter is grounded, safely allowing the modular converter to be scaled up to a higher voltage and power control level. Moreover, a fail-normal switch (FNS) can bypass the converters in case of fault or malfunction.

Despite the merit of low-cost, enhanced safety and higher scalability, the existing MCT still faces two limitations: (i) the GFL control on the B2B converters utilizes phase-locked-loop (PLL), which could potentially trigger small-signal instability due to inappropriate control gain [9] or transient instability in low voltage condition [8]; (ii) in the power flow control mode, the series-connected converter consumes certain power from the DC link to provide grid-side power flow control, while the shunt-connected converter drains power from the grid to balance the DC link. In this mode, both B2B converters cannot actively inject transient grid-supporting power.

In contrast, the exemplary fractionally-rated active grid dampening system 100 (e.g., 100a, 100b), while based on the existing MCT concept, can address the aforementioned challenges and respectively enhance the grid support in load transient, low-frequency power oscillation, black-start process, and three-phase-to-ground short-circuit fault. The features of the exemplary fractionally-rated active grid dampening system (e.g., 100a, 100b) may include GFM operation on the shunt converter that can instantaneously change the current and power injection to the grid due to its voltage source characteristic. The transient response of GFM is faster than GFL, and a better grid-supporting capability is expected [10]. Depending on the grid transient, different control modes can be activated.

The features of the exemplary fractionally-rated active grid dampening system (e.g., 100a, 100b) may include energy storage capabilities on the DC link that decouples the power flow of both B2B converters and enables higher grid-supporting power injection in grid transients.

The features of the exemplary fractionally-rated active grid dampening system (e.g., 100a, 100b) may include a retrofittable function for the existing line transformer that can employ cost-effective building block that includes a shunt transformer and fractionally rated B2B converters on the line to achieve all the grid-supporting functionality.

The features of the exemplary fractionally-rated active grid dampening system (e.g., 100a, 100b) may include a network transient damper based on an existing FACTS device. Compared to a stand-alone inverter-based damper [12], the exemplary fractionally-rated active grid dampening system (e.g., 100a, 100b) may be owned and controlled by the grid operator. Its parameter setting is transparent to the grid operator and to other “Grid Formers”. This overcomes one of the aforementioned challenges of high IBR penetration that the IBRs manufactured by different vendors with incompatible parameters tend to conflict with each other and degrade the system stability.

### Example Control System

Computer-executable instructions, such as program modules, being executed by a computer may be used. Generally, program modules include routines, programs, objects, components, data structures, etc., that perform particular tasks or implement particular abstract data types. In its most basic configuration, the controller includes at least one processing unit and memory. Depending on the exact configuration and type of computing device, memory may be volatile (such as random-access memory (RAM)), non-volatile (such as read-only memory (ROM), flash memory, etc.), or some combination of the two. The controller may have additional features/functionality.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be implemented across a plurality of devices. Such devices might include personal computers, network servers, handheld devices, and wearable devices, for example.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] G. Strbac et al., “Decarbonization of Electricity Systems in Europe: Market Design Challenges,” in IEEE Power and Energy Magazine, vol. 19, no. 1, pp. 53-63, January-February 2021, doi: 10.1109/MPE.2020.3033397.
[2] J. Morris, K. Calhoun, J. Goodman and D. Seif, “Reducing solar PV soft costs: A focus on installation labor,” 2014 IEEE 40th Photovoltaic Specialist Conference (PVSC), Denver, CO, USA, 2014, pp. 3356-3361, doi: 10.1109/PVSC.2014.6925654.
[3] Kundur, Prabha S., and Om P. Malik. 2022. Power System Stability and Control. 2nd ed. New York: McGraw Hill.
[4] U. Markovic, O. Stanojev, P. Aristidou, E. Vrettos, D. Callaway and G. Hug, “Understanding Small-Signal Stability of Low-Inertia Systems,” in IEEE Transactions on Power Systems, vol. 36, no. 5, pp. 3997-4017, September 2021, doi: 10.1109/TPWRS.2021.3061434.
[5] Narain G. Hingorani, Laszlo Gyugyi, “Understanding FACTS: Concepts and Technology of Flexible AC Transmission Systems”, 10 Dec. 1999, ISBN:9780470546802—DOI: 10.1002/9780470546802
[6] R. P. Kandula, A. Iyer, R. Moghe, J. E. Hernandez, and D. Divan, “Power router for meshed systems based on a fractionally rated back-to-back converter,” IEEE Transactions on Power Electronics, vol. 29, no. 10, pp. 5172-5180, 2014.
[7] E. Durna, J. Benzaquen, R. P. Kandula and D. Divan, “Autonomous Fail-Normal Switch for Hybrid Transformers,” 2021 IEEE Energy Conversion Congress and Exposition (ECCE)
[8] Xin, Huanhai et al. (2022) How Many Grid-Forming Converters do We Need?A Perspective From Power Grid Strength.
[9] Dissertation from Heng Wu, “Small-Signal and Transient Stability Analysis of Voltage-Source Converters”, Aalborg University, Denmark, April 2020
[10] Ray, Ishita, “Grid-Forming Converter Control Method to Improve DC link Stability in Inverter-Based AC Grids.” PhD diss., University of Tennessee, 2021. URL: https://trace.tennessee.edu/utk graddiss/6726
[11] S. K. Samal and P. C. Panda, “Damping of power system oscillations by using unified Power Flow Controller with POD and PID controllers,” 2014 International Conference on Circuits, Power and Computing Technologies [ICCPCT-2014], Nagercoil, India, 2014, pp. 662-667, doi: 10.1109/ICCPCT.2014.7054911.
[12] R. W. Kenyon, A. Sajadi, A. Hoke and B.-M. Hodge, “Using a Grid-Forming Inverter to Stabilize a Low-Inertia Power System—Maui Hawaiian Island, “2022 IEEE PES Innovative Smart Grid Technologies Conference Europe (ISGT-Europe), Novi Sad, Serbia, 2022, pp. 1-6, doi: 10.1109/ISGT-Europe54678.2022.9960290.

### REFERENCE LIST #2

[1′] R. P. Kandula, A. Iyer, R. Moghe, J. E. Hernandez and D. Divan, “Power Router for Meshed Systems Based on a Fractionally Rated Back-to-Back Converter,” in IEEE Transactions on Power Electronics, vol. 29, no. 10, pp. 5172-5180, October 2014.
[2′] Lin, Yashen, Joseph H. Eto, Brian B. Johnson, Jack D. Flicker, Robert H. Lasseter, Hugo N. Villegas Pico, Gab-Su Seo, Brian J. Pierre, and Abraham Ellis. Research roadmap on grid-forming inverters. No. NREL/TP-5D00-73476. National Renewable Energy Lab. (NREL), Golden, CO (United States), 2020.
[3′] J. Benzaquen, M. Miranbeigi, P. Kandula and D. Divan, “Collaborative Autonomous Grid-Connected Inverters: Flexible grid-forming inverter control for the future grid,” in IEEE Electrification Magazine, vol. 10, no. 1, pp. 22-29, March 2022.
[4′] Matevosyan, Julia, Babak Badrzadeh, Thibault Prevost, Eckard Quitmann, Deepak Ramasubramanian, Helge Urdal, Shun Hsien Huang, Vijay Vital, Jon O'Sullivan, and Ryan Quint. “Will Grid Forming Inverters be the Key for High Renewable Penetration?.” (2019).
[5′] L. Gyugyi, C. D. Schauder, S. L. Williams, T. R. Rietman, D. R. Torgerson and A. Edris, “The unified power flow controller: a new approach to power transmission control,” in IEEE Transactions on Power Delivery, vol. 10, no. 2, pp. 1085-1097, April 1995.
[6′] L. Gyugyi, “Dynamic compensation of AC transmission lines by solid-state synchronous voltage sources,” in IEEE Transactions on Power Delivery, vol. 9, no. 2, pp. 904-911, April 1994.
[7′] F. Kreikebaum, D. Das, Y. Yang, F. Lambert and D. Divan, “Smart Wires A distributed, low-cost solution for controlling power flows and monitoring transmission lines,” 2010 IEEE PES Innovative Smart Grid Technologies Conference Europe (ISGT Europe), 2010, pp. 1-8.
[8′] Divan et al., Power Flow Controller With A Fractionally rated Back-To-Back Converter. U.S. Pat. No. 9,281,756 B2. Mar. 8, 2016.
[9′] Divan et al., Hybrid Transformer Systems And Methods. U.S. Pat. No. 11,004,596 B2. May 8, 2021.
[10′] R. P. Kandula et al., “Field test results for a 3-phase 12.47 kV 1 MVA power router,” 2016 IEEE Energy Conversion Congress and Exposition (ECCE), 2016, pp. 1-8.
[11′] Kandula, Rajendra Prasad, et al. Modular controllable transformers (MCT). No. DE-OE0000855. Georgia Institute of Technology, Atlanta, GA (United States), 2018.

1. A system comprising:
system terminals, including (i) a first input terminal, or a set thereof, and (ii) a second output terminal, or a set thereof, to couple in series to a secondary-side winding of a distribution or transmission transformer of a distribution or transmission system;
a first stage fail-normal disconnection switch having a disconnection switch device that couples of the first input terminal, or the set thereof, of the system terminals;
a second stage conversion and energy storage module coupled to the first stage fail-normal disconnection switch, the second stage conversion and energy storage module comprising a series converter and a shunt converter coupled to one or more energy storage equipment via a DC bus,
a third stage transformer comprising a transformer having a first winding side and a second winding side, the first winding side coupled to outputs of the second stage conversion and energy storage module, and the second winding side coupled to the second output terminal or a set thereof; and
a controller operatively coupled to the series converter and the shunt converter, the controller being configured, via computer readable instructions, to direct operation of the series converter and the shunt converter through the third stage transformer and the one or more energy storage equipment, as a network transient damper, to (i) control steady-state line power flow and voltages at the distribution or transmission transformer, and (ii) provide dynamic shunt and series damping to grid transients at the distribution or transmission transformer.

2. The system of claim 1, wherein the distribution or transmission transformer configured with a first power rating, wherein the series converter and the shunt converter are configured with components for a second power rating, wherein the transformer is configured with components for a second power rating, the second power rating and a third power rating being less than 20% of the first power rating.

3. The system of claim 1, wherein the controller is configured, via the computer readable instructions, to direct operation of the series converter and the shunt converter, to provide the dynamic shunt and series damping to grid transients through the third stage transformer and the one or more energy storage equipment, including load transient damping, power oscillation damping, black-start, and low-voltage or line short-circuit ride-through.

4. The system of claim 1, wherein the series converter and/or shunt converter comprises a standard or off-the-shelf motor-drive back-to-back inverter.

5. The system of claim 4, wherein the standard or off-the-shelf motor-drive back-to-back inverter includes a bidirectional motor drive that connects to an intermediate DC bus of an energy storage battery, either directly, or through a DC/DC converter.

6. The system of claim 1, wherein the series converter and/or the shunt converter comprises 2-level/3-level voltage source converters (VSC) or modular multilevel converters (MMCs).

7. The system of claim 1, wherein the series converter is configured, via active regulation, to absorb instantaneous angle differences to damp oscillations and energy swings between regions in the distribution or transmission system.

8. The system of claim 1, wherein the controller is configured to direct operation of the series converter and the shunt converter through the third stage transformer and the one or more energy storage equipment in grid-forming control (GFM) mode when state-of-charge (SOC) of the one or more energy storage equipment is above a pre-defined threshold, and wherein the controller is configured to direct operation of the series converter and the shunt converter through the third stage transformer and the one or more energy storage equipment in grid-following control (GFL) mode when the state-of-charge (SOC) of the one or more energy storage equipment is below a pre-defined threshold.

9. The system of claim 1, wherein the controller is configured, via the computer readable instructions, to direct operation of the series converter and the shunt converter, to provide the steady-state line power flow at the distribution or transmission transformer for at least one function of:
energy/power balance,
power flow control,
congestion management,
asset utilization,
VAR/Voltage support,
energy storage, or
a combination thereof.

10. The system of claim 1, wherein the controller is configured, via the computer readable instructions, to direct operation of the series converter and the shunt converter, to provide the dynamic shunt and series damping to grid transients at the distribution or transmission transformer for at least one function of:
damping,
stability,
protection,
fault-recovery, or
a combination thereof.

11. A method comprising:
retrofitting a distribution or transmission transformer in distribution or transmission infrastructure with a retrofittable fractionally-rated active grid dampening system, by connecting terminals of the retrofittable fractionally-rated active grid dampening system in series to a secondary-side winding of the distribution or transmission transformer, wherein the retrofittable fractionally-rated active grid dampening system comprises:
system terminals, including (i) a first input terminal, or a set thereof, and (ii) a second output terminal, or a set thereof, to couple in series to the secondary-side winding of the distribution or transmission transformer;
a first stage fail-normal disconnection switch having a disconnection switch device that couples of the first input terminal, or the set thereof, of the system terminals;
a second stage conversion and energy storage module coupled to the first stage fail-normal disconnection switch, the second stage conversion and energy storage module comprising a series converter and a shunt converter coupled to one or more energy storage equipment via a DC bus,
a third stage transformer comprising a transformer having a first winding side and a second winding side, the first winding side coupled to outputs of the second stage conversion and energy storage module, and the second winding side coupled to the second output terminal or a set thereof; and
a controller operatively coupled to the series converter and the shunt converter, the controller being configured, via computer readable instructions, to direct operation of the series converter and the shunt converter through the third stage transformer and the one or more energy storage equipment, as a network transient damper, to (i) control steady-state line power flow at the distribution or transmission transformer and (ii) provide dynamic shunt and series damping to grid transients at the distribution or transmission transformer.

12. A method of controlling a grid comprising:
sensing a distribution or transmission transformer via a retrofittable fractionally-rated active grid dampening system, wherein the retrofittable fractionally-rated active grid dampening system includes (i) a conversion and energy storage module coupled comprising a series converter and a shunt converter coupled to one or more energy storage equipment via a DC bus and (ii) a transformer having a first winding side and a second winding side, the first winding side coupled to outputs of the conversion and energy storage module, and the second winding side coupled to a secondary winding of the distribution or transmission transformer; and
executing a grid-forming control operation at the retrofittable fractionally-rated active grid dampening system for steady-state regulation and/or dynamic control by dynamically provide virtual inertia and damp undesired oscillations through injection of appropriate voltages and currents at fractional power level, via the series converter and shunt converter through the one or more energy storage equipment.

13. The method of claim 12, wherein the retrofittable fractionally-rated active grid dampening system includes a controller configured to perform power-flow control.

14. The method of claim 12, wherein the controller of the retrofittable fractionally-rated active grid dampening system is configured to perform voltage regulation control.

15. The method of claim 12, wherein the controller of the retrofittable fractionally-rated active grid dampening system is configured to perform impedance control.

16. The method of claim 12, wherein the retrofittable fractionally-rated active grid dampening system includes a dynamic controller configured for at least one of grid-forming operation, inertia support, active damping, fault and phase jumps, or a combination thereof.

17. The method of claim 12, wherein the series converter is configured, via active regulation, to absorb instantaneous angle differences, via control of the series converter and the shunt converter in regulating power to the one or more energy storage equipment, to damp oscillations and energy swings between regions in a distribution or transmission system of the distribution or transmission transformer.

18. The method of claim 12, wherein a controller of the retrofittable fractionally-rated active grid dampening system is configured to direct operation of the series converter and the shunt converter through the transformer and the one or more energy storage equipment in grid-forming control (GFM) mode when state-of-charge (SOC) of the one or more energy storage equipment is above a pre-defined threshold, and wherein the controller is configured to direct operation of the series converter and the shunt converter through the transformer and the one or more energy storage equipment in grid-following control (GFL) mode when the state-of-charge (SOC) of the one or more energy storage equipment is below a pre-defined threshold.

19. The method of claim 18, wherein the controller is configured, via the computer readable instructions, to direct operation of the series converter and the shunt converter, to provide the steady-state line power flow at the distribution or transmission transformer for at least one function of:
energy/power balance,
power flow control,
congestion management,
asset utilization, VAR/Voltage support,
energy storage, or
a combination thereof.

20. (canceled)

21. The method of claim 11, wherein the first stage disconnection switch is configured to bypass the second stage conversion and energy storage module during a detected fault event associated with the second stage conversion and energy storage module.

22. (canceled)
